(19) United States
(12) Patent Application Publication
(10) Pub. No.: US 2002/0074086 A1
(43) Pub. Date: Jun. 20, 2002

(54) Adhesive composition and optical device using the same

(76) Inventors: Koichiro Nakamura, Osaka (JP); Masahiro Hori, Osaka (JP); Hiroaki Yamamoto, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 09/963,554

(22) Filed: Sep. 27, 2001

Related U.S. Application Data
(60) Provisional application No. 60/236,366, filed on Sep. 29, 2000.

(51) Int. Cl. C09J 1/00

(52) U.S. Cl. 156/329; 524/731

(57) ABSTRACT

To prepare an adhesive which has excellent heat resistance, suppresses the formation of bubbles during curing and is free from such a defect as opacity caused by the bubbles.

The adhesive composition comprises (A) an organopolysiloxane having two alkenyl groups with 4 or less carbon atoms bonded to silicon atoms in one molecule and a molecular weight of 1,000 or more, (B) an organohydrogenpolysiloxane having at least two hydrogen atoms bonded to silicone atoms in one molecule and a molecular weight of 1,000 or more, (C) a platinum-based catalyst, and (D) an organic silicon compound having at least three alkenyl groups with 4 or less carbon atoms bonded to silicon atoms in one molecule and a molecular weight of less than 1,000 or an organic cyclic silicon compound having at least three hydrogen atoms bonded to silicon atoms in one molecule and a molecular weight of less than 1,200.

### FIELD OF THE INVENTION

The present invention relates to an adhesive composition and to an optical device constructed by bonding together optical parts by an optically transparent adhesive layer which is a cured product of the adhesive composition.

### PRIOR ART

Technologies for increasing communication capacity have been becoming more and more important due to the popularization of the Internet. Bonding technologies used for the assembly of optical parts and optical elements used in these optical fiber communication systems must have high reliability and such characteristic properties as the precise adjustment of refractive index (for connecting optical paths), precise position accuracy (for bonding lenses) and high heat resistance (soldering heat resistance and heat resistance at the time of vacuum film formation). Soldering, laser welding and organic adhesives such as acrylic and epoxy resins have been used or an adhesive made from an organic-inorganic composite material prepared by a sol-gel method has been proposed to assemble optical parts. (i) A fluorinated or sulfur-containing epoxy adhesive and epoxy acrylic adhesive are proposed in Proceedings of the 48th ECTC, pp. 1178 to 1185, 1998 and (ii) an organic-inorganic adhesive prepared by a sold-gel method is described in (ii) Journal of Non-Crystalline Solids, vol. 80, pp. 557-563, 1986 and (iii) Intl. Congr. On Glass, pp. 429to 436, 1986. An optical element using a sold-gel adhesive made from an alkoxide and a metal salt is disclosed by (iv) Japanese Patent No. 1829914 (Japanese Patent Laid-Open Publication No. 62-297369) and a prism using an adhesive made from a silicic acid salt and an alkoxide, is disclosed by (v) Japanese Patent No. 2786996. Further, an optical element using an organic-inorganic composite adhesive, for example, an adhesive obtained by hydrolyzing a sol comprising polydimethylsiloxane, methyltriethoxysilane and phenyltrifluorosilane is disclosed by (vi) U.S. Pat. No. 5,991,493.

However, the above bonding technologies and adhesives for optical parts have the following problems.

The soldering and laser welding are unsatisfactory in terms of fixing position accuracy and need a laser light source and advanced technologies. The epoxy adhesive and acrylic adhesive (i) are inferior in heat resistance of 250° C. or more (soldering heat resistance). The adhesives made from an alkoxide and a metal salt (ii to vi) have such a problem that an alcohol formed by hydrolysis or water formed by dehydration is gasified during curing by heating, whereby bubbles remain by bonding optical parts such as lenses, the adhesive becomes opaque, or sufficient adhesion cannot be obtained.

### SUMMARY OF THE INVENTION

It is an object of the present invention to provide an adhesive which has improved the above problems, is excellent in heat resistance, suppresses the formation of bubbles at the time of curing, is free from such a defect as opacity caused by bubbles and can be used for the assembly and bonding of optical parts as well as an optical device constructed by bonding optical parts using the adhesive.

Other objects and advantages of the present invention will become apparent from the following description.

Firstly, according to the present invention, the above objects and advantages of the present invention are attained by an adhesive composition which comprises the following components (A) to (D):

(A) an organopolysiloxane having two alkenyl groups with 4 or less carbon atoms bonded to silicon atom in one molecule and a molecular weight of 1,000 or more;

(B) an organohydrogenpolysiloxane having at least two hydrogen atoms bonded to silicone atom in one molecule and a molecular weight of 1,000 or more;

(C) a platinum-based catalyst; and

(D) at least one selected from the group consisting of an organic silicon compound (D-1) having at least three alkenyl groups with 4 or less carbon atoms bonded to silicon atom in one molecule and a molecular weight of less than 1,000 and an organic cyclic silicon compound (D-2) having at least three hydrogen atoms bonded to silicon atom in one molecule and a molecular weight of less than 1,200.

Secondly, the above objects and advantages of the present invention are attained by an optical device constructed by bonding together optical parts using the adhesive composition of the present invention.

### BRIEF DESCRIPTION OF DRAWINGS

FIG. 1 is a sectional view of a first embodiment of the present invention;

FIG. 2 is a sectional view of another embodiment of the present invention;

FIG. 3 is a sectional view of still another embodiment of the present invention;

FIG. 4 is a sectional view of a further embodiment of the present invention;

FIG. 5 is a sectional view of a still further embodiment of the present invention;

FIG. 6 is a sectional view of a still further embodiment of the present invention;

FIG. 7 is a sectional view of a still further embodiment of the present invention; and

FIG. 8 is a sectional view of a still further embodiment of the present invention.

### PREFERRED EMBODIMENTS OF THE INVENTION

A description is first given of the adhesive composition of the present invention. The component (A) constituting the adhesive composition of the present invention is an organopolysiloxane having two alkenyl groups in the molecule each of which is directly bonded to a silicon atom and has 4 or less carbon atoms. The siloxane skeleton contained in the component (A) may be straight-chain, branched, cyclic or a mixture thereof. The alkenyl group having 4or less carbon atoms is preferably a vinyl group, vinyloxy group, allyl group, aryloxy group, acryl group, acryloxy group, methacryl group, methacryloxy group or 1-butenyl group from the viewpoints of easy synthesis, out of which a vinyl group is more preferred. The substituent bonded to a silicon atom other than the alkenyl group is an alkyl group such as methyl, ethyl, propyl, butyl, hexyl or dodecyl, aryl group such as phenyl, aralkyl group such as 2-phenylethyl or 2-phenylpropyl, or substituted hydrocarbon group such as chloromethyl or 3,3,3-trifluoropropyl. They may be used alone or in combination of two or more. Out of these, what have at least one substituent selected from the group consisting of methyl, phenyl and 3,3,3-trifluoropropyl are preferred because synthesis is easy, the degree of polymerization for obtaining required physical and mechanical properties after curing is easily obtained, heat resistance is achieved and refractive index can be adjusted. The component (A) serves as a base polymer for an addition reaction type curable polyorganosiloxane, and 0.04 mol % or more of all the organic groups bonded to silicon atoms in the component (A) are preferably an alkenyl group. The viscosity of the component (A) is not particularly limited but preferably 100 cS or more at 25° C. When fluidity is required before curing, the viscosity of the component (A) is preferably 250,000 cS or less. When the molecular weight of the component (A) is too small, the component (A) has low viscosity and poor coatability. Therefore, the component (A) must have a molecular weight of 1,000 or more, preferably 2,000 or more, more preferably 5,000 or more.

The component (A) is a dimethylsiloxane polymer having a vinyl group at both terminals represented by the following formula (1) , vinylmethylsiloxane-dimethylsiloxane copolymer represented by the following formula (2), diphenylsiloxane-dimethylsiloxane copolymer having a vinyl group at both terminals represented by the following formula (3) or methyltrimethylpropylsiloxane dimethylsiloxane having a vinyl group at both terminals represented by the following formula (4).

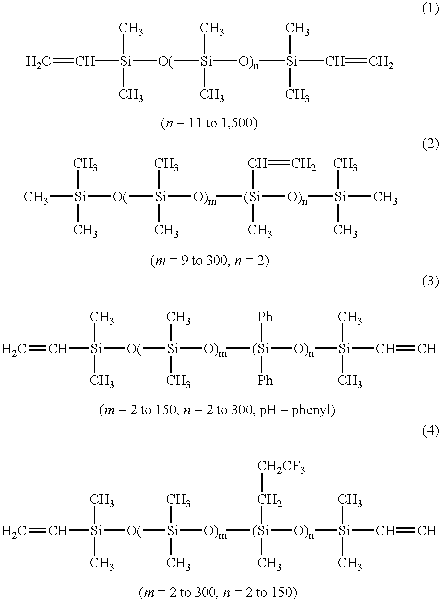

The polyorganohydrogensiloxane as the component (B) used in the present invention is necessary to form a basic skeleton constituting the adhesive layer by an addition reaction between it and the polyorganosiloxane containing an alkenyl group as the component (A) and is an organic silicon compound having at least two hydrogen atoms bonded to silicon atoms in one molecule and a molecular weight of 1,000 or more. A straight-chain silicon compound is preferably used. Examples of the organic group bonded to a silicon atom other than hydrogen atoms in the component (B) include alkyl groups such as methyl, ethyl, propyl, butyl, hexyl and dodecyl, aryl groups such as phenyl, aralkyl groups such as 2-phenylethyl and 2-phenylpropyl, and substituted hydrocarbon groups such as chloromethyl and 3,3,3-trifluoropropyl. They may be used alone or in combination of two or more. Out of these, the component (B) preferably has at least one substituent selected from the group consisting of methyl, phenyl and 3,3,3-trifluoropropyl because it is easily synthesized, easily obtains a degree of polymerization for achieving required physical and mechanical properties after curing, has heat resistance and can adjust refractive index. When the molecular weight of the component (B) is too small, the component (B) has low viscosity and poor coatability. Therefore, it must have a molecular weight of 1,000 or more.

Illustrative examples of the component (B) include hydrogen terminated polydimethylsiloxane compounds represented by the following formula (5), methylhydrogensiloxane-dimethylsiloxane copolymer compounds represented by the following formula (6), polyphenyl(dimethylhydrogensiloxane)siloxane hydrogen terminated compounds represented by the following formula (7), methyltrifluoropropylsiloxane(dimethylsiloxane)copolymer represented by the following formula (8), polymethylhydrogensiloxane compounds, polyethylhydrogensiloxane compounds and methylhydrogensiloxane-phenylmethylsiloxane copolymer compounds.

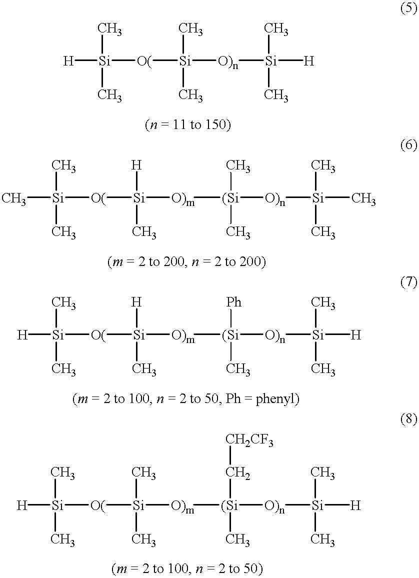

The platinum-based catalyst (component (C)) used in the adhesive composition of the present invention is, for example, a platinum-siloxane complex, platinum-olefin complex, platinum-(β-diketone) complex, platinum-azo complex or the like. Preferred examples of the platinum-based catalyst include platinum-carbonylvinylmethyl complex, platinum-divinyltetramethyldisiloxane complex, platinum-cyclovinylmethylsiloxane complex, platinum-octylaldehyde/octanol complex and the like. The amount of the platinum-based catalyst added is 10 to 1,000 ppm based on the total weight of the components (A), (B) and (D). This amount is preferred because it enables the platinum-based catalyst to maintain an appropriate curing speed and have an appropriate pot life.

A description is subsequently given of the component (D) used in the adhesive composition of the present invention. The component (D) in the present invention is added to improve the physical and mechanical strengths of the adhesive layer formed by an addition reaction between the polyorganosiloxane containing alkenyl groups as the component (A) and the hydrogenpolyorganosiloxane as the component (B). Since the component (D) serves as a crosslinking agent for forming a 3-D network, it must have three or more reactive points per molecule. The reactive points are sites where a bond such as a covalent bond, coordinate bond, ion bond, π-π bond or dipole-dipole bond can be provided. Out of these, the component (D) preferably has a reactive site between an alkenyl group and a hydrogen atom which is a reactive site between the component (A) and the component (B). The component (D) is at least one of an organic silicon compound (D-1) which has at least three alkenyl groups with 4 or less carbon atoms bonded to silicon atoms in one molecule and a molecular weight of less than 1,000 and an organic cyclic silicon compound (D-2) which has at least three hydrogen atoms bonded to silicon atoms in one molecule and a molecular weight of less than 1,200. These silicon compounds have excellent heat resistance. When the molecular weight of the component (D) is too large, the component (D) has high viscosity and poor coatability. Therefore, the component (D-1) has a molecular weight of less than 1,000 and the component (D-2) has a molecular weight of less than 1,200. Preferably, the component (D-1) has a molecular weight of 700 or less and the component (D-2) has a molecular weight of 1,100 or less. When the component (D) is the component (D-1), each of the alkenyl groups contained in the component (D-1) reacts and combines with one hydrogen atom in the component (B) of at least three molecules to play the key role of forming a 3-D network in the adhesive layer. When the component (D) is the component (D-2), each of the hydrogen atoms contained in the component (D-2) reacts and combines with one alkenyl group in the component (A) of at least three molecules.

The component (D-1) is a siloxane compound, silane compound or silazane compound having three or more alkenyl groups in one molecule. Illustrative examples of the component (D-1) include what have three vinyl groups and a molecular weight of less than 1,000 such as tris(vinyldimethylsiloxy)methylsilane (molecular weight of 346.72), tris(vinyldimethylsiloxy)phenylsilane (molecular weight of 408.78), trivinylchlorosilane (molecular weight of 144.67), trivinylethoxysilane (molecular weight of 154.37), trivinylmethoxysilane (molecular weight of 140.25), trivinylmethylsilane (molecular weight of 124.26), 1,3,5-trivinyl-1,1,3,5,5-pentamethyltrisiloxane (molecular weight of 272.57), trivinylsilane (molecular weight of 110.22), 1,3,5-trivinyl-1,3,5-trimethylcyclotrisilazane (molecular weight of 255.54), 1,3,5-trivinyl-1,3,5-trimethylcyclotrisiloxane (molecular weight of 258.50), methacryloxypropyltris(vinyldimethylsiloxy)silane (molecular weight of 458.85) and boronvinyldimethylsiloxide (molecular weight of 314.41); what have 4 or more vinyl groups and a molecular weight of less than 1,000 such as tetrakis(vinyldimethylsiloxy)silane (molecular weight of 432.88), 1,1,3,3-tetravinyldimethyldisiloxane (molecular weight of 340.72), tetravinylsilane (molecular weight of 136.27), 1,3,5,7-tetravinyl-1,3,5,7-tetramethylcyclotetrasilazane (molecular weight of 340.72), 1,3,5,7-tetravinyl-1,3,5,7-tetramethylcyclotetrasiloxane (molecular weight of 344.66), octavinyl-T8-silsesquioxane (molecular weight of 633.04), pentavinylpentamethylcyclopentasiloxane (molecular weight of 430.82) and hexavinyldisiloxane (molecular weight of 234.45); what have 3 or more allyl groups, allyloxy groups or methacryloxy groups and a molecular weight of less than 1,000such as tetraallyloxysilane (molecular weight of 256.37), tetraallylsilane (molecular weight of 192.37) and tetrakis(2-methacryloxyethoxy)silane (molecular weight of 544.66).

The component (D-2) is a cyclic siloxane compound or cyclic silazane compound having 3 or more active hydrogen atoms in one molecule. Illustrative examples of the component (D-2) include hydro-T8-silsesquioxane (molecular weight of 424.74, 8 hydrogen atoms), octakis(dimethylsiloxy)-T8-silsequioxane (molecular weight of 1017.98, 8 hydrogen atoms), methylhydrocyclosiloxane (molecular weight of 240 to 360, 3 to 5 hydrogen atoms), pentamethylcyclopentasiloxane (molecular weight of 300.64, 5 hydrogen atoms), phenylhydrocyclosiloxane (molecular weight of 366.58 to 488.78, 3 to 4 hydrogen atoms), tetraethylcyclotetrasiloxane (molecular weight of 296.61, 4 hydrogen atoms), 1,3,5,7-tetraethyl-2,4,6,8-tetramethylcyclotetrasilazane (molecular weight of 348.78, 4 hydrogen atoms), 1,3,5, 7-tetramethylcyclotetrasiloxane (molecular weight of 240.51, 4 hydrogen atoms) and 1,3,5-trimethylcyclotrisiloxane (molecular weight of 180.38, 3 hydrogen atoms). The number of hydrogen atoms in the parentheses indicates the number of hydrogen atoms bonded to silicon atoms.

The amount of the component (D) is preferably 0.1 to 40 wt %, more preferably 0.5 to 25 wt % based on the total weight of the component (A) and the component (B) to improve the mechanical strength and environmental resistance of the adhesive layer.

As for the contents of the component (A), the component (B), the component (D-1) and the component (D-2) in the adhesive composition, the number of hydrogen atoms contained in the component (B) and the component (D-2) is preferably 0.4 to 6.0 times, more preferably 0.6 to 4.0 times the total number of alkenyl groups contained in the component (A) and alkenyl groups contained in the component (D-1).

Out of the components (D), an oligomer having 3 to 8 silicon atoms is preferred because (1) it has good compatibility with the components (A), (B) and (C), (2) it has such a high boiling point that it hardly forms bubbles in the adhesive layer and hardly discharges gas to the outside, and (3) it has high heat resistance. Cyclic oligomers having 3 to 8 silicon atoms such as 1,3,5-trivinyl-1,3,5-trimethylcyclotrisiloxane and 1,3,5,7-tetravinyl-1,3,5,7-tetramethylcyclotetrasiloxane are particularly preferred as the component (D-1). Cyclic oligomers having 3 to 8 silicon atoms such as 1,3,5,7-tetraethylcyclotetrasiloxane (molecular weight of 296.61) and 1,3,5,7-tetraethylcyclotetrasiloxane and 1,3,5,7-tetramethylcyclotetrasiloxane are particularly preferred as the component (D-2).

An adhesive layer having improved adhesion is provided. to an adherend to be bonded using the adhesive composition. of the present invention, exemplified by an inorganic material such as glass, plastic or metal, organic material or organic-inorganic composite material. A primer layer maybe, formed on the surface of the adherend in contact with the adhesive composition. A reduction in adhesion caused by delamination can be improved by forming the primer layer. Compounds for forming the primer layer include silane coupling agents such as sulfur-containing alkoxysilane compounds having at least one sulfur atom and at least two alkoxy groups bonded to silicon atoms in one molecule, nitrogen-containing alkoxysilane compounds having at least one nitrogen atom and at least two alkoxy groups bonded to silicon atoms in one molecule and epoxy-containing alkoxysilane compounds having at least one epoxy group and at least two alkoxy groups bonded to silicon atoms in one molecule, and hydrolyzed and dehydrated condensate compounds thereof.

The adhesive composition of the present invention provides an adhesive layer having excellent mechanical and physical strengths, environmental resistance and heat resistance and is advantageously used to bond optical parts because its refractive index can be adjusted by selecting the organic group of a polysiloxane skeleton. It can be used for connecting the optical paths of two or more optical parts and bonding others and for application purposes other than for optical parts.

When the adhesive composition of the present invention is used to bond together the optical paths of two or more optical parts, an optical device having a small bonding loss can be provided by adjusting the contents of the components (A), (B) and (D) such that the refractive index value of the adhesive layer should approximate to the refractive index values of at least two optically transparent optical parts. In concrete terms, when the refractive indices of the two adjacent optical parts are represented by n₁ and n₂ (n₁>n₂), the adhesive layer between the adjacent optical parts preferably has a refractive index n₃ represented by the following expression (1), more preferably a refractive index n₃ represented by the following expression (2).

{square root over ((n₁·n₂)})−(({square root over ((n₁·n₂)})−n₂)/3)−0.05≦n₃≦{square root over ((n₁·n₂)})+((n₁−{square root over ((n₁·n₂)}))/3)+0.05 (1)

{square root over ((n₁·n₂)})−(({square root over ((n₁·n₂)})−n₂)/4)−0.03≦n₃≦{square root over ((n₁·n₂)})+((n₁−{square root over ((n₁·n₂)}))/4)+0.03 (2)

For example, in the case of bonding together optical fibers, when the refractive indices of the cores of optical fibers are 1.45, 1.40≦n₃≦1.50 according to the expression (1) and 1.42≦n₃ 1.48 according to the expression (2). By adjusting the refractive index of the adhesive layer, an optical device having a small light propagation loss is obtained. As for optical parts other than optical fibers, such as lenses, filters, optical waveguides, diffraction gratings and optically active elements, optical devices having a small light propagation loss are obtained by adjusting the refractive index.

A description is subsequently given of the optical parts of the present invention. The optical parts of the present invention include optical fibers, lenses, filters, optical waveguides, diffraction gratings and optically active elements. The optical fibers include a single-mode optical fiber and multi-mode optical fiber. The lenses include a refractive index distribution lens, spherical lens, non-spherical lens and plane-convex lens. The optical filters include a narrow-band filter made from a dielectric multi-layer film, band-pass filter and polarization filter. The optical waveguides include a single-mode optical waveguide, multi-mode optical waveguide and what have a Bragg diffraction grating with a periodically modulated refractive index. Materials constituting these optical parts include glass materials, plastic materials, metals and organic-inorganic composite materials.

The materials constituting the above optical parts preferably have a linear expansion coefficient of 1.5×10⁻⁵/° C. or less. When the linear expansion coefficient of a matrix is larger than 1.5×10^{31 5}/° C., in the case of a plastic optical part having a high thermal expansion coefficient of 9 to 15×10⁻⁵/° C. such as polypropylene, delaminationmay occur between the optical part and the adhesive layer in the heating step after the application of an adhesive and the adhesive layer may crack. Ordinary inorganic glass has a linear expansion coefficient of 1.5×10⁻⁵/° C. or less. At least the bonding surface of an optical part is preferably made from an oxide. If the bonding surface is not made from an oxide, the adhesion strength of the adhesive layer lowers in the molding step and delamination occurs between the surface to be bonded and the adhesive layer as the case may be. Preferred examples of the material of the matrix include oxide glass such as silicate-based glass, boric acid-based glass and phosphoric acid-based glass, quartz, ceramics, epoxy resins, glass fiber reinforced polystyrene and the like. Although a metal is not bonded by the adhesive layer of the present invention as it is, if the surface of a metal is treated with an oxidizing agent, it is bonded to another material. Therefore, it can be used as a part to be bonded.

When these optical parts are assembled together, the optically transparent adhesive composition of the present invention is placed, filled or spread between a first optical part and a second optical part and then cured to form a bonding portion having predetermined strength. As for the curing of the adhesive, an adhesive composition which cures in a few minutes can be obtained by increasing the amount of a curing catalyst. By reducing the amount of a curing catalyst, an adhesive composition having a pot life of a several hours can be obtained. The curing time can be shortened by heating as required. A reaction retardant and a curing accelerator may be added as required in an amount of 40% or less, preferably 30% or less based on the total amount. The curing time can be controlled freely by adding a reaction retardant or a curing accelerator. Strength can be improved by adding a reinforcing agent. The reinforcing agent is an organic fine particle or inorganic fine particle. It is preferably an inorganic fine particle from the viewpoint of heat resistance. Examples of the inorganic fine particle include silica, titania, alumina, zirconia, ceria, calcium carbonate and the like. The amount of the reinforcing agent is preferably 40 wt % or less, more preferably 20 wt % or less. The particle diameter of the reinforcing agent is preferably 1 μm or less, more preferably 0.5 μm or less to secure the transparency of the adhesive layer. It is preferred from the viewpoint of transparency that the refractive index of the reinforcing agent added should be made substantially equal to the refractive index of the matrix.

### EXAMPLES

Optical Parts

Optical Fiber

A glass single-mode optical fiber (clad diameter: 120 μm, core diameter: 10 μm, refractive index of core: 1.46, refractive index of clad: 1.44) was prepared.

Lens

A glass microlens (Celfoc Microlens SMC18 of Nippon Sheet Glass Co., Ltd., diameter: 1.8 mm, length: 4.43 mm(0.23 pitch, refractive index of center portion: 1.590, distribution coefficient g=0.326, 1 pitch(=2π/g)=19.27 mm) was prepared.

Curved Lens

A glass microlens (Celfoc Microlens LBP20of Nippon Sheet Glass Co., Ltd., diameter: 2.0 mm, length: about 1.5 mm (NA=0.3)) was prepared.

Filter

A bandpass filter obtained by forming a silicon oxide layer (refractive index: 1.46) and a titanium oxide layer (refractive index: 2.1) alternately on one side of a glass matrix (refractive index: 1.46) was prepared.

Optical Waveguide

A photoradical generating agent was added in an amount of 3 wt % based on the total amount to a liquid composition obtained by mixing a silica raw material solution prepared by hydrolyzing acryloxypropyltrimethoxysilane with 0.1 N hydrochloric acid and a zirconia raw material obtained by treating zirconium tetrabutoxide with an equimolar amount of acrylic acid in a Si/Zr ratio of 1:1 to obtain a solution for forming an optical waveguide. This solution was applied to a silicon substrate having a 8 μm silica film (V-shaped groove for fixing an optical fiber was formed in the end portion) by spin coating and heated at 80° C. for 10 minutes, and a waveguide portion was exposed to light by a high-pressure mercury lamp (10 mW for 15 seconds) through a photomask. An unexposed portion was dissolved and removed by isopropanol. A liquid composition containing silicon and zirconium in a ratio of 1.2:1 was applied to the coating film and dried to obtain an embedded waveguide.

Waveguide Type Diffraction Grating

A Bragg grating was formed on the above optical waveguide by a double-beam interference exposure method to obtain a waveguide type diffraction grating.

The refractive index values of the relevant sites of the above optical parts are shown in Table 1.

TABLE 1

| optical part | refractive index |
|---|---|
| optical fiber (core) | 1.45 |
| lens (center) | 1.59 |
| optical waveguide (core) | 1.52 |
| optical filter | 1.46 |

Preparation of Adhesive Composition

component (A)=vinyl terminated polydimethylsiloxane (viscosity: 1,000 cS, molecular weight: 28,000, abbreviated as VPDMS) and vinyl terminated diphenylsiloxane-dimethylsiloxane copolymer (viscosity: 5,000 cS, molecular weight: 35,300, abbreviated as VDPhS-DMS) component (B)=methylhydrogensiloxane-dimethylsiloxane copolymer (viscosity: 25 to 35 cS, molecular weight: about 2,000, abbreviated as MHS-DMS) and methyltrifluoropropylsiloxane(dimethylsiloxane)copolymer (molecular weight: about 2,000, abbreviated as MTFPS)

component (C)=platinum-divinyltetramethyldisiloxane complex

component (D-1)=1,3,5,7-tetravinyl-1,3,5,7-tetramethylcyclotetrasiloxane (molecular weight: 344.66, abbreviated as TVTMSTS), 1,3,5-trivinyl-1,3,5-trimethyltrisiloxane (molecular weight: 258.50, abbreviated as TVTMTS) and tetraallyloxysilane (molecular weight: 256.37, abbreviated as TAOS)

component (D-2)=1,3,5,7-tetramethylcyclotetrasiloxane (molecular weight: 240.51, abbreviated as TMSTS) and 1,3,5,7-tetraethyl-2,4,6,8-tetramethylcyclotetrasilazane (molecular weight: 348.78, abbreviated as TETMSTS)

### Examples 1 to 6 and Comparative Example 1

Adhesive compositions (N to U) were obtained by adding the above components as shown in Table 2 such that the number of hydrogen atoms contained in the component (B) and the component (D-2) should be 0.4 to 6.0 times the total number of alkenyl groups contained in the component (A) and alkenyl groups contained in the component (D-1) and adding and mixing 100 ppm of the component (C) based on the total weight of the components (A) to (D).

TABLE 2

| | | component (A) | | component (B) | | component (D) | | ratio of number of |
|---|---|---|---|---|---|---|---|---|
| | | | quantity | | quantity | | quantity | hydrogen atoms to total |
| number | adhesive | type | (wt %) | type | (wt %) | type | (wt %) | number of alkenyl groups |
| Ex. 1 | N | VPDMS | 90 | MHS-DMS | 7.5 | TVTMSTS | 2.5 | 0.9 |
| Ex. 2 | P | VPDMS | 80 | MHS-DMS | 15 | TVTMTS | 5 | 0.9 |
| Ex. 3 | Q | VDPhS-DMS | 90 | MHS-DMS | 7.5 | TVTMSTS | 2.5 | 1.0 |
| Ex. 4 | R | VPDMS | 90 | MHS-DMS | 7.5 | TETMSTS | 2.5 | 0.9 |
| Ex. 5 | S | VPDMS | 90 | MTFPS | 8.0 | TMSTS | 2.0 | 1.0 |
| Ex. 6 | T | VDPhS-DMS | 90 | MHS-DMS | 8.0 | TAOS | 2.0 | 1.2 |
| C. Ex. 1 | U | VPDMS | 98 | MHS-DMS | 2.0 | — | — | 1.1 |

Ex.: Example
C. Ex.: Comparative Example
VPDMS: vinyl terminated polydimethylsiloxane (viscosity: 1,000 cS, molecular weight: 28,000)
VDPhS-DMS: vinyl terminated diphenylsiloxane-dimethylsiloxane copolymer (viscosity: 5,000 cS, molecular weight: 35,300)
MHS-DMS: methylhydrogensiloxane-dimethylsiloxane copolymer (viscosity: 30cS, molecular weight: 2,000)
MTFPS: methyltrifluoropropylsiloxane(dimethylsiloxane)copolymer (molecular weight: 2,000)
TVTMSTS: 1,3,5,7-tetravinyl-1,3,5,7-tetramethylcyclotetrasiloxane (molecular weight: 344.66)
TVTMTS: 1,3,5-trivinyl-1,3,5-trimethyltrisiloxane (molecular weight: 258.50)

Measurement of Adhesive Strength and Others

10 mg of each of the above adhesive compositions (N to U) was dropped onto a first slide glass plate (25 mm×50 mm×1.2 mm) and a second slide glass plate was placed upon the glass plate immediately to spread the adhesive composition to a size of 25 mm×25 mm and heated on a hot plate at 200° C. for 15 minutes. The appearance of the adhesive layer formed between the first and second slide glass plates was observed to check the formation of air bubbles and the existence of opacity. 1 g of the adhesive composition was placed in a glass sample bottle having a capacity of 3 ml and heated at 200° C. for 30 minutes to measure its volumes before and after heating to evaluate its volume shrinkage factor (%) represented by 100×(volume before heating−volume after heating)/(volume before heating). The above adhesive composition was spread between two slide glass plates likewise and maintained at room temperature for 24 hours and then at room temperature, 100° C. or 200° C. for 1 hour as shown in the table. To evaluate the initial adhesive strength (cohesive failure rate) of the adhesive layer, the glass plates on both sides of the adhesive layer were pulled in opposite directions at a rate of 50 cm/min by a tensile tester to measure adhesive strength (shearing strength) (N/mm²). As a durability test, adhesive strength after the adhesive layer was boiled for 24 hours and adhesive strength after the adhesive layer was left in a thermostatic oven maintained at a temperature of 85° C. and a relative humidity of 85% for 500 hours (high-temperature high-humidity test) after the above boiling were measured in the same manner as described above.

Comparative Example 2

1.33 ml of polydimethylsiloxane (PDMS), 35.6 ml of methyltriethoxysilane (MTES) and 2.67 ml of phenyltrifluorosilane (PTFS) were added to a 100 ml sample tube (molar ratio of 8:83:9), the tube was capped, and they were stirred at room temperature for 5 minutes. The resulting mixture was heated at 70° C., and 5.4 g of water was added and vigorously stirred for 30 minutes. The reaction mixture was first separated into two layers and became uniform after that. The mixture was exposed to the atmosphere for 1 day and the solvent was dried naturally by opening the tube to obtain an adhesive composition. The adhesive composition was checked for the formation of bubbles and the existence of opacity during a heat treatment and measured for its volume shrinkage and adhesive strength in the same manner as the above adhesive compositions (N to U).

The results of Examples 1 to 6 and Comparative Examples 1 and 2 are shown in Tables 3 and 4. In Examples 1 to 6, the formation of bubbles was not observed during the heat treatment, the volume shrinkage was less than 0.1%, the initial value of adhesive strength and the value of adhesive strength after a boiling test were 5 N/mm² or more, and the adhesive strength after the high-temperature and high-humidity test was 4 N/mm² or more. The rupture of the adhesive layer after the adhesive strength test did not occur at an interface between it and glass but a rupture was seen in the interior of the adhesive layer. In contrast to this, in Comparative Example 1, adhesive strength, particularly adhesive strength after the boiling test and after the high-temperature and high-humidity test was unsatisfactory. In Comparative Example 2, bubbles were formed during the heat treatment and air bubbles were formed continuously from the center to the end portions of the glass. Due to the formation of gas, volume shrinkage was large and adhesive strength was not satisfactory. The rupture of the adhesive layer after the adhesive strength test did not occur at the interface between it and glass but the rupture of the inside of the adhesive layer caused by the existence of bubbles in the adhesive layer and the rupture of the adhesive layer itself were observed. The above formation of bubbles causes the opacity and impaired light transmission of the adhesive layer as well as an increase in the light transmission loss of a bonded optical part. The volume shrinkage of the adhesive layer causes a light transmission loss or the internal distortion or cracking of the adhesive layer due to a change in the distance between optical parts to be bonded together (such as dislocation of the focusing point in the case of bonding a lens to another optical part), whereby the optical properties of the optical parts are easily impaired.

TABLE 3

| | | | appearance | | |
|---|---|---|---|---|---|
| | | | of adhesive layer | | Shrinkage |
| | | refractive | formation of | | factor |
| number | adhesive | index | bubbles | opacity | (%) |
| Ex. 1 | N | 1.45 | non-existent | non-existent | less than |
| | | | | | 0.1 |
| Ex. 2 | P | 1.44 | non-existent | non-existent | less than |
| | | | | | 0.1 |
| Ex. 3 | Q | 1.50 | non-existent | non-existent | less than |
| | | | | | 0.1 |
| Ex. 4 | R | 1.44 | non-existent | non-existent | less than |
| | | | | | 0.1 |
| Ex. 5 | S | 1.45 | non-existent | non-existent | less than |
| | | | | | 0.1 |
| Ex. 6 | T | 1.50 | non-existent | non-existent | less than |
| | | | | | 0.1 |
| C. Ex. 1 | U | 1.43 | non-existent | non-existent | less than |
| | | | | | 0.1 |
| C. Ex. 2 | — | 1.43 | existent | existent | 60 |

Ex.: Example
C. Ex.: Comparative Example

TABLE 4

| | | | shearing strength (N/mm²) | | |
|---|---|---|---|---|---|
| | | | | | after high- |
| | | heat treatment | | after | temperature |
| | | temperature (° C.) | | boiling | and high- |
| number | adhesive | (1 hour) | initial | test | humidity test |
| Ex. 1-1 | N | room temperature | 7 | 7 | 7 |
| Ex. 1-2 | N | 100 | 7 | 7 | 7 |
| Ex. 1-3 | N | 200 | 7 | 7 | 7 |
| Ex. 2-1 | P | room temperature | 6 | 6 | 6 |
| Ex. 2-2 | P | 100 | 6 | 6 | 6 |
| Ex. 2-3 | P | 200 | 8 | 8 | 8 |
| Ex. 3-1 | Q | 100 | 5 | 5 | 5 |
| Ex. 3-2 | Q | 200 | 5 | 5 | 5 |
| Ex. 4 | R | 200 | 5 | 5 | 4 |
| Ex. 5 | S | 200 | 6 | 5 | 5 |
| Ex. 6 | T | 200 | 5 | 5 | 4 |
| C. Ex.1 | U | 200 | 4 | 2 | 2 |
| C. Ex.2 | — | — | 3 | 2 | 2 |

Ex.: Example
C. Ex.: Comparative Example

### Example 7

Bonding Optical Fibers

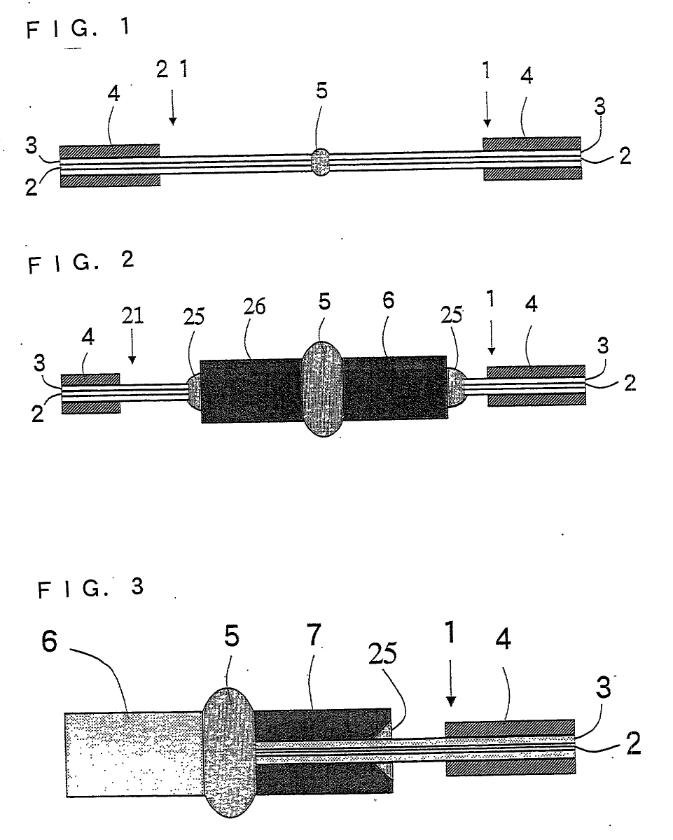

As shown in FIG. 1, 2 cm of a polymer coating layer 4 was removed from end portions of first and second single-mode glass optical fibers 1 and 21 described above (length of about 1 m), each having the polymer coating layer 4, core portion 2 and clad portion 3, and the end portions were butted against each other through an about 25 μm long air gap to align their centers with each other on an optical bench (not shown). The positions of the optical fibers were adjusted such that the value of optical loss became minimum when laser light having a wavelength of 1,550 nm was input from the other end portion of the first optical fiber 1, let pass through the first fiber and output from the other end portion of the second optical. fiber 21. In this state, the adhesive composition N (5) was applied to the position of the air gap between the two fibers and cured by leaving at room temperature for 2 hours or by heating the applied position with 110° C. hot air from a drier for about 5 minutes. The initial value of optical loss before the application of the adhesive and the value of optical loss after the application and curing of the adhesive were measured and the results are shown in Table 5.

### Example 8

Bonding Lenses

As shown in FIG. 2, one end portions of two single-mode glass optical fibers 1 and 21 described above (having a length of about 1 m and a polymer coating layer 4 was removed from one end portions), each having the polymer coating layer 4, core portion 2 and clad portion 3, were bonded to one end portions of two glass microlenses 6 and 26 described above (Celfox Microlens SMC18) by an adhesive 25. The other end portions of the microlenses 6 and 26 were butted against each other to align their centers with each other on an optical bench (not shown). The positions of the lenses were adjusted such that the value of optical loss became minimum when laser light having a wavelength of 1,550 nm was input from the other end portion of the first optical fiber 1, let pass through the first microlens 6 and output from the other end portion of the second optical fiber 21 through an about 250 μm air gap and the second microlens 26. In this state, the adhesive composition Q (5) was applied between the two lenses 6 and 26 and cured by leaving at room temperature for 2 hours or by heating with 110° C. hot air from a drier for about 5 minutes. The initial value of optical loss (before the application of the adhesive) and the value of optical loss after the application and curing of the adhesive were measured and the results are shown in Table 5.

### Example 9

Bonding Lens to Optical Fiber, Formation of Collimater Module

As shown in FIG. 3, one end of the optical fiber 1 was inserted into a glass ferrule 7 and fixed with the optical fiber in a recess portion of the end portion of the ferrule 7 by an adhesive Q (25). The centers of this ferrule with the fiber and the above glass microlens 6 were aligned with each other on an optical bench such that the value of optical loss became minimum when laser light having a wavelength of 1,550 nm was input from the other end portion of the optical fiber 1 fixed in the ferrule and output to the outside from the microlens 6 through an about 250 μm air gap. The adhesive composition Q (5) was applied between the lens 6 and the ferrule 7 and cured by leaving at room temperature for 2 hours or by heating with 110° C. hot air from a drier to fabricate a collimater module. The initial value of optical loss (before the application of the adhesive) and the value of optical loss after the application and curing of the adhesive were measured and the results are shown in Table 5.

### Example 10

Bonding Lens to Filter

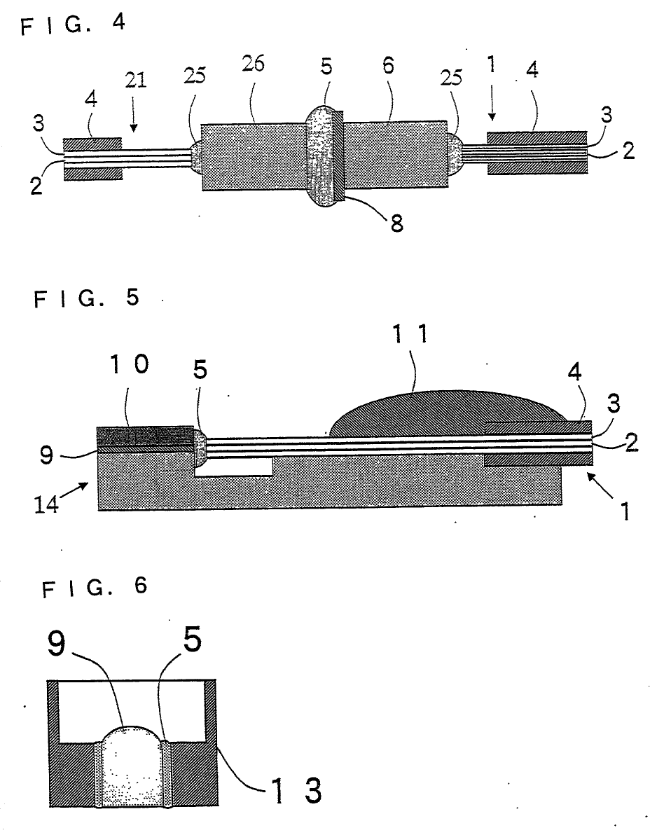

A lens and a filter were bonded together as shown in FIG. 4 in the same manner as in Example 8 except that lens fitted with the above filter 8 and the above lens 6 was used in place of the first lens and the adhesive composition P (5) was used in place of the adhesive Q in Example 8 for bonding lenses. The initial value of optical loss before the application of the adhesive and the value of optical loss after the application and curing of the adhesive were measured and the results are shown in Table 5.

### Example 11

Bonding Fiber to Optical Waveguide

As shown in FIG. 5, 2 cm of a polymer coating layer 4 was removed from the end portion of the above single-mode glass optical fiber 1 (length of about 1 m) having the polymer coating layer 4, core portion 2 and clad portion 3, the optical fiber was fixed in a V-shaped groove as a waveguide by an adhesive 11, and the end portion of the optical fiber 1 was butted against the end portion of the optical waveguide core 9 of the above optical waveguide element 14 through an about 25 μm long air gap to align their centers with each other. The position of the optical fiber 1 was adjusted such that the value of optical loss became minimum when laser light having a wavelength of 1,550 nm was input from the other end portion of the first optical fiber, let pass through the first fiber and output from the other end portion of the optical waveguide core. The adhesive Q was applied to the position of the air gap between the end surface of the optical fiber 1 and the end surface of the optical waveguide core 9 and cured by leaving at room temperature for 2 hours or by heating the applied portion with 110° C. hot air from a drier for about 5 minutes. The initial value of optical loss before the application of the adhesive and the value of optical loss after the application and curing of the adhesive composition were measured and the results are shown in Table 5.

### Example 12

Bonding Fiber to Optical Waveguide Type Diffraction Grating

A fiber and an optical waveguide type diffraction grating were bonded together in the same manner as in Example 11 except that the above waveguide type diffraction grating was used in place of the waveguide element used in Example 11 and the adhesive composition T was used in place of the adhesive composition Q used in Example 11 and measured in the same manner as in Example 11. The results are shown in Table 5.

TABLE 5

| Ex. | | | | output with | output after curing of |
|---|---|---|---|---|---|
| Number | first optical part | second optical part | adhesive | air gap (dB · m) | adhesive (dB · m) |
| 7 | optical fiber | optical fiber | N | 11.5 | 11.2 |
| 8 | lens | lens | Q | 11.0 | 10.1 |
| 9 | lens | optical fiber | Q | 11.7 | 11.3 |
| 10 | lens | optical filter | P | 20.4 | 19.2 |
| 11 | optical fiber | optical waveguide | Q | 15.1 | 14.8 |
| 12 | optical fiber | optical waveguide type | T | 15.1 | 14.8 |
| | | diffraction grating | | | |

Ex.: Example

### Example 13

Bonding Lens to Lens Holder

As shown in FIG. 6, the above curved lens 9 was fitted in a stainless lens holder 13 (SF20T of Nippon Sheet Glass Co., Ltd.), and the adhesive composition N (5) was filled into the space between the outer wall of the curved lens and the lens holder and cured by leaving at room temperature for 2 hours or by heating with 110° C. hot air from a drier to bond the lens to the lens holder. This bonded product was evaluated for its airtightness (initial airtightness) before 24 hours of boiling and airtightness after boiling. An airtightness test was made by reducing the pressure of a space on one side of the lens holder to 5 Pa or less, supplying He gas to the other space of the lens holder and measuring the amount of He gas leaking into the depressurized space through the adhesive layer between the curved lens and the lens holder with a gas detector. When the amount of the He gas was less than 1.0×10¹⁰ (Pa·m³/s), airtightness (hermetic sealing properties) was evaluated as excellent (∘), when the amount was the above value or more to less than 1.0×10⁻⁷ (Pa·m³/s), airtightness was evaluated as good (Δ) and when the amount was 1.0×10⁻⁷ (Pa·m³/s) or more, airtightness was evaluated as poor (X). As shown in Table 6, the initial airtightness and the airtightness after boiling were both excellent.

### Example 14

Bonding Lens to Ferrule

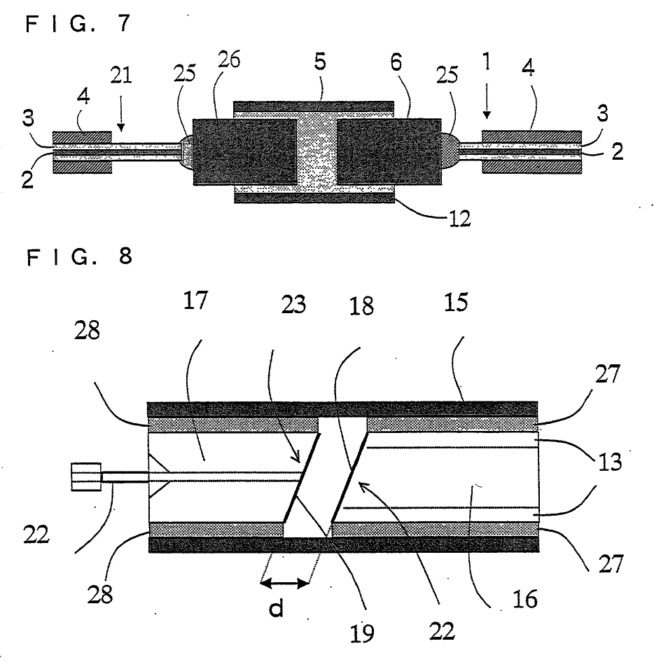

Lenses were bonded together in the same manner as in Example 8 except that the adhesive composition Q (5) was applied to and filled into the space surrounded by the lens 6 and 26 and a stainless ferrule 12 as shown in FIG. 7 in place of the adhesive composition Q applied between the lenses 6 and 26. This bonded product was evaluated for its airtightness before and after a boiling test in the same manner as in Example 13. As shown in Table 6, the initial airtightness and the airtightness after boiling were both excellent.

### Example 15

Bonding Optical Fibers and Lens to Sleeve

The above glass microlens was fitted into a quartz cylindrical holder, and the adhesive R was filled into the space between the lens and the holder and cured by leaving at room temperature for 2 hours or by heating with 110° C. hot air from a driver. One end surface of the lens with the holder was polished to form an end surface inclined at 80 from a plane perpendicular to the optical axis, and an anti-reflection laminate consisting of a silica thin film and a titania thin film was formed on the end surface. A ferrule with a fiber was prepared in the same manner as in Example 9. The end surface of the ferrule with a fiber was inclined and formed as described above and an anti-reflection laminate was formed on the end surface. As shown in FIG. 8, a lens 16 with a holder 13 and a ferrule 17 with a fiber 22 were placed in a stainless (SUS) or zirconia cylindrical sleeve 15 so that the inclined end surfaces 22 and 23 having the anti-reflection laminates 18 and 19 formed thereon so as to become parallel to each other with an interval d of 250 μm therebetween to align the centers of the lens 16 and the ferrule 17 with each other on an optical bench (not shown). The adhesive S (27) was filled into the space between the lens 16 with a holder and the sleeve 15 according to a capillary phenomenon and cured by leaving at room temperature for 2 hours or by heating with 110° C. hot air from a drier. And then, the adhesive S (28) was filled into the space between the ferrule 17 with a fiber and the sleeve 15 and cured in the same manner as described above to bond the optical fiber to the lens through the sleeve. This bonded product was evaluated by the airtightness test before and after a boiling test in the same manner as in Example 13. The both amount of He gas before and after the boiling test was less than 1.0×10⁻¹⁰ (Pa·m³/s). Thus, the initial airtightness and the airtightness after boiling were both excellent.

### Example 16

20 g of vinyl terminated polydimethylsiloxane (molecular weight: 28,000, viscosity: 1,000 cs, to be abbreviated as DMS-V31 hereinafter) and 15 mg of platinum-divinyltetramethyldisiloxane complex were mixed together under agitation to obtain a uniform solution. After 1.8 g of 1,3,5,7-tetravinyl-1,3,5,7-tetramethylcyclotetrasiloxane was added to 0.8 g of the solution and stirred, 1.8 g of vinyl terminated polydimethylsiloxane (molecular weight: 49,500, viscosity: 5,000 cs) and 5.4 g of DMS-V31 were added and stirred to prepare a matrix. 0.2 g of a methylhydroxysiloxane-dimethylsiloxane copolymer was added to 0.5 g of the above matrix to prepare an adhesive.

When slide glass sheets were bonded together by applying this adhesive as descried above and heating at 150° C. for 30 minutes, a bonding strength of 4.7 N/mm² was obtained. Further, when a solution consisting of tetraethoxysilane, vinyltriethoxysilane, tetrabutoxytitanium and hexane in a weight ratio of 1/0.5/0.5/10 was applied to the slide glass sheets as a primer and the slide glass sheets were bonded by means of the above adhesive, the bonding strength was 5.3 N/mm² which was higher than when the primer was not used.

### Comparative Example 3

A lens and a holder were bonded together in the same manner as in Example 13 except that the adhesive composition obtained in Comparative Example 2 was used in place of the adhesive composition N used in Example 13. This bonded product was evaluated by the above airtightness test before and after a boiling test in the same manner as Example 13. As shown in Table 6, the initial airtightness was excellent but the airtightness after boiling was lower than that of Example 13.

TABLE 6

| | | | | airtightness | |
|---|---|---|---|---|---|
| | first | second | | | after boiling test |
| number | part | part | adhesive | initial | (24 hours) |
| Ex. 13 | lens | lens | N | ◯ | ◯ |
| | | holder | | | |
| Ex. 14 | lens | ferrule | Q | ◯ | ◯ |
| C. Ex. 3 | lens | lens | C. Ex. 2 | ◯ | Δ |
| | | holder | | | |

Ex.: Example
C. Ex.: Comparative Example
◯: <1.0 × 10⁻¹⁰ (Pa · m³/s),
Δ: <1.0 × 10⁻⁷ (Pa · m³/s)

As described above, according to the present invention, an adhesive composition which has excellent adhesive strength and environmental resistance (heat resistance, weatherability, moisture resistance and chemical resistance) and has a small light transmission loss while preventing gas formation and shrinkage in the step of curing and bonding and an optical device constructed by bonding optical parts by the adhesive composition are obtained.

1. An adhesive composition comprising the following components:
(A) an organopolysiloxane having two alkenyl groups with 4 or less carbon atoms bonded to silicon atom in one molecule and a molecular weight of 1,000 or more;
(B) an organohydrogenpolysiloxane having at least two hydrogen atoms bonded to silicone atom in one molecule and a molecular weight of 1,000 or more;
(C) a platinum-based catalyst; and
(D) at least one selected from the group consisting of an organic silicon compound (D-1) having at least three alkenyl groups with 4 or less carbon atoms bonded to silicon atom in one molecule and a molecular weight of less than 1,000 and an organic cyclic silicon compound (D-2) having at least three hydrogen atoms bonded to silicon atom in one molecule and a molecular weight of less than 1,200.

2. The adhesive composition of claim 1, wherein the number of hydrogen atoms contained in the component (B) and the component (D-2) is 0.4 to 6.0 times the total number of alkenyl groups contained in the component (A) and alkenyl groups contained in the component (D-1), the component (C) is contained in an amount of 10 to 1,000 ppm based on the total weight of the components (A), (B) and (D), and the component (D) is contained in an amount of 0.1 to 40 wt % based on the total weight of the components (A) and (B).

3. The adhesive composition of claim 1 or 2, wherein the component (D) is an oligomer having 3 to 8 silicon atoms.

4. The adhesive composition of claim 1 or 2, wherein the component (D-1) is selected from the group consisting of boronvinyldimethylsiloxide, hexavinyldisiloxane, methacryloxypropyltris(vinyldimethylsiloxy)silane, octavinyl-T8-silsesquioxane, pentavinylpentamethylcyclopentasiloxane, tetraallyloxysilane, tetraallylsilane, tetrakis(2-methacryloxyethoxy)silane, tetrakis(vinyldimethylsiloxy)silane, 1,1,3,3-tetravinyldimethyldisiloxane, tetravinylsilane, 1,3,5,7-tetravinyl-1,3,5,7-tetramethylcyclotetrasilazane, 1,3,5,7-tetravinyl-1,3,5,7-tetramethylcyclotetrasiloxane, tris(vinyldimethylsiloxy)methylsilane, tris(vinyldimethylsiloxy)phenylsilane, trivinylchlorosilane, trivinylethoxysilane, trivinylmethoxysilane, trivinylmethylsilane, 1,3,5-trivinyl-1,1,3,5,5-pentamethyltrisiloxane, trivinylsilane, 1,3,5-trivinyl-1,3,5-trimethylcyclotrisilazane and 1,3,5-trivinyl-1,3,5-trimethylcyclotrisiloxane.

5. The adhesive composition of claim 1 or 2, wherein the component (D-2) is selected from the group consisting of hydro-T8-silsesquioxane, octakis (dimethylsiloxy)-T8-silsesquioxane, methylhydrocyclosiloxane, pentamethylcyclopentasiloxane, phenylhydrocyclosiloxane, 1,3,5,7-tetramethylcyclotetrasiloxane, 1,3,5,7-tetraethylcyclotetrasiloxane and 1,3,5,7-tetraethyl-2,4,6,8-tetramethylcyclotetrasilazane.

6. The adhesive composition of claim 1 or 2, wherein the component (D-1) is
1,3,5-trivinyl-1,3,5-trimethylcyalotrisiloxane or
1,3,5,7-tetravinyl-1,3,5,7-tetramethylcyclotetrasiloxane
and the component (D-2) is
1,3,5,7-tetraethylcyclotetrasiloxane or
1,3,5,7-tetramethylcyclotetrasiloxane.

7. The adhesive composition of claim 1, wherein the component (A) has a viscosity of 100 to 250,000 cS at 25° C.

8. An optical device constructed by bonding optical parts by the adhesive composition of claim 1.

9. The optical device of claim 8, wherein the optical parts are optical fibers, lenses, filters, optical waveguides, diffraction gratings or optically active elements.

10. The optical device of claim 8 or 9, wherein the optical parts are made from glass, plastics, metals or organic-inorganic composite materials.

11. An optical device constructed by bonding at least two optically transparent optical parts by an optically transparent adhesive layer formed by curing the adhesive composition of claim 1, wherein the value of refractive index of the adhesive layer was adjusted to approximate to the values of refractive index of the at least two optically transparent: optical parts.

12. The optical device of claim 11, wherein when the refractive indices of the two adjacent optical parts are represented by n₁ and n₂ (n₁≧n₂), the adhesive layer between the adjacent optical parts has a refractive index n₃ represented by the following expression (1):
{square root over ((n₁·n₂)})−(({square root over ((n₁·n₂)})−n₂)/3)−0.05≦n₃≦{square root over ((n₁·n₂)})+((n₁−{square root over ((n₁·n₂)}))/3)+0.05 (1)

13. The optical device of claim 11, wherein when the refractive indices of the two adjacent optical parts are represented by n₁ and n₂ (n₁≧n₂), the adhesive layer between the adjacent optical parts has a refractive index n₃ represented by the following expression (2):
{square root over ((n₁·n₂)})−(({square root over ((n₁·n₂)})−n₂)/4)−0.03≦n₃≦{square root over ((n₁·n₂)})+((n₁−{square root over ((n₁·n₂)}))/4)0.03 (2)
